(19) United States
(12) Patent Application Publication
(10) Pub. No.: US 2021/0181730 A1
(43) Pub. Date: Jun. 17, 2021

(54) ROBOT SYSTEM AND CONTROL DEVICE FOR ROBOT

(71) Applicant: SEIKO EPSON CORPORATION, Tokyo (JP)

(72) Inventor: Atsushi SASAKI, AZUMINO-SHI (JP)

(21) Appl. No.: 17/117,127

(22) Filed: Dec. 10, 2020

(30) Foreign Application Priority Data
Dec. 11, 2019 (JP) 2019-223949

(51) Int. Cl. G05B 23/02; B25J 9/16

(52) U.S. Cl. CPC G05B 23/0208; B25J 9/1653; B25J 9/1674

(57) ABSTRACT

A robot system includes: a robot arm; a drive unit; an encoder; a drive control unit transmitting and receiving a first communication packet and a second communication packet in this order to and from the encoder and controlling an operation of the drive unit, based on a content of the first communication packet and the second communication packet; a storage unit storing the first communication packet and the second communication packet; a first timer unit having a time making a cycle of a finite time period, the first timer unit causing the storage unit to store a first time when the first communication packet is stored into the storage unit and a second time when the second communication packet is stored into the storage unit; and a second timer unit measuring an elapsed time of a state of no communication after the first communication packet is detected.

The present application is based on, and claims priority from JP Application Serial Number 2019-223949, filed Dec. 11, 2019, the disclosure of which is hereby incorporated by reference herein in its entirety.

### BACKGROUND

### 1. Technical Field

The present disclosure relates to a robot system and a control device for a robot.

### 2. Related Art

JP-A-2007-26028 discloses a microcomputer abnormality detection device having a timer clock generation unit, a free-running counter, a second timer clock generation unit, a second free-running counter, a comparison unit, and a determination unit. Of these units, the timer clock generation unit and the second timer clock generation unit generate a timer clock and a second timer clock, based on a system clock. The free-running counter counts, based on the timer clock. The second free-running counter counts, based on the second timer clock. The comparison unit compares the values of the free-running counter and the second free-running counter. The determination unit determines that the free-running counter has an abnormality when the values of the two free-running counters compared by the comparison unit do not coincide with each other.

JP-A-2007-26028 also discloses that the free-running counter is formed of a counter circuit with a predetermined number of bits and that, when a carry occurs, the free-running counter is reset to zero and subsequently performs count-up again.

A case where an abnormality occurs, for example, in the second free-running counter, of the free-running counter and the second free-running counter described in JP-A-2007-26028, is now considered. In this case, it is assumed that, due to the abnormality that has occurred, the second free-running counter happens to stop counting for the same period as the period of resetting the second free-running counter and subsequently restarts counting. In such a case, even when the value of the free-running counter and the value of the second free-running counter after the restart are compared with each other, the determination unit cannot detect the abnormality in the second free-running counter, which has stopped counting. When such an abnormality detection device is applied to a robot system, the correct position of a robot arm cannot be detected. Therefore, there is a problem in that the operation accuracy of the robot arm drops.

### SUMMARY

A robot system according to an application example of the present disclosure includes: a robot arm; a drive unit driving the robot arm; an encoder detecting a position of the robot arm; a drive control unit transmitting and receiving a first communication packet and a second communication packet in this order to and from the encoder and controlling an operation of the drive unit, based on a content of the first communication packet and the second communication packet; a storage unit storing the first communication packet and the second communication packet; a first timer unit having a time making a cycle of a finite time period, the first timer unit causing the storage unit to store a first time, which is the time when the first communication packet is stored into the storage unit, and a second time, which is the time when the second communication packet is stored into the storage unit; and a second timer unit measuring an elapsed time of a state of no communication after the first communication packet is detected.

### BRIEF DESCRIPTION OF THE DRAWINGS

FIG. 1 is a side view showing a robot system according to an embodiment.

FIG. 2 is a block diagram of the robot system shown in FIG. 1.

FIG. 3 is a table showing an example of data stored in a communication packet storage unit shown in FIG. 2.

FIG. 4 is a table showing a first operation example of a control device.

FIG. 5 is a flowchart for explaining a communication monitoring method by a communication monitoring unit.

FIG. 6 is a table showing a second operation example of the control device.

FIG. 7 is a table showing a third operation example of the control device.

FIG. 8 is a table showing a fourth operation example of the control device.

FIG. 9 is a table showing a fifth operation example of the control device.

### DESCRIPTION OF EXEMPLARY EMBODIMENTS

A preferred embodiment of a robot system and a control device for a robot according to the present disclosure will now be described in detail with reference to the accompanying drawings.

First, the robot system according to the embodiment is described.

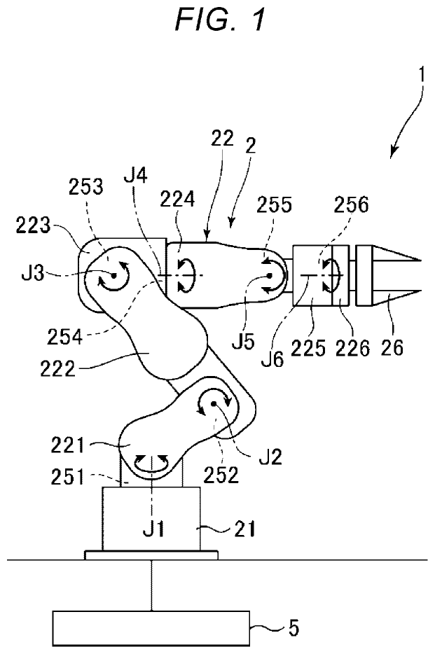

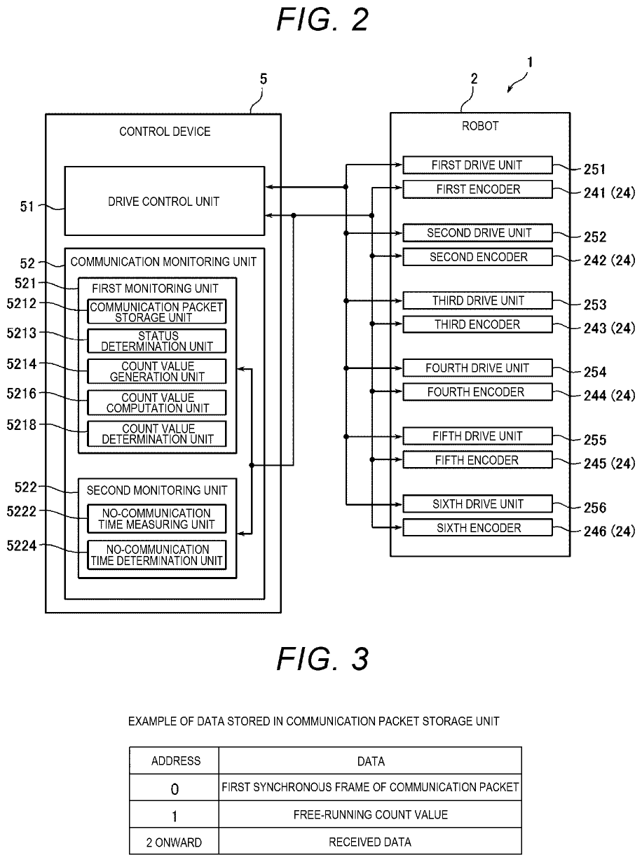

FIG. 1 is a side view showing the robot system according to the embodiment. FIG. 2 is a block diagram of the robot system shown in FIG. 1.

### 1. Outline of Robot System

A robot system 1 shown in FIG. 1 has a robot 2 and a control device 5 controlling the operation of the robot 2. The use of the robot system 1 is not particularly limited and may be, for example, supply, removal, transport, and assembly or the like of a target object such as a precision device or a component forming a precision device.

### 1.1. Robot

The robot 2 shown in FIG. 1 has a base 21 and a robot arm 22 coupled to the base 21.

The base 21 is fixed to an installation target part such as a floor, wall, ceiling, or movable trolley.

The robot arm 22 has an arm 221 coupled to the base 21 in such a way as to be able to swivel about a first axis J1, an arm 222 coupled to the arm 221 in such a way as to be able to swivel about a second axis J2, an arm 223 coupled to the arm 222 in such a way as to be able to swivel about a third axis J3, an arm 224 coupled to the arm 223 in such a way as to be able to swivel about a fourth axis J4, an arm 225 coupled to the arm 224 in such a way as to be able to swivel about a fifth axis J5, and an arm 226 coupled to the arm 225 in such a way as to be able to swivel about a sixth axis J6. An end effector 26 corresponding to work to be executed by the robot 2 is attached to the arm 226.

The robot 2 is not limited to the configuration in this embodiment. For example, the number of arms of the robot arm 22 may be one to five, or seven or more. The type of the robot 2 may be a SCARA robot or a dual-arm robot having two robot arms 22.

The robot 2 has a first drive unit 251, a second drive unit 252, a third drive unit 253, a fourth drive unit 254, a fifth drive unit 255, and a sixth drive unit 256, as shown in FIG. 2. The first drive unit 251 has a motor, not illustrated, causing the arm 221 to swivel in relation to the base 21, and a speed reducer, not illustrated. The second drive unit 252 has a motor, not illustrated, causing the arm 222 to swivel in relation to the arm 221, and a speed reducer, not illustrated. The third drive unit 253 has a motor, not illustrated, causing the arm 223 to swivel in relation to the arm 222, and a speed reducer, not illustrated. The fourth drive unit 254 has a motor, not illustrated, causing the arm 224 to swivel in relation to the arm 223, and a speed reducer, not illustrated. The fifth drive unit 255 has a motor, not illustrated, causing the arm 225 to swivel in relation to the arm 224, and a speed reducer, not illustrated. The sixth drive unit 256 has a motor, not illustrated, causing the arm 226 to swivel in relation to the arm 225, and a speed reducer, not illustrated.

The control device 5 controls the operation of each of the first drive unit 251, the second drive unit 252, the third drive unit 253, the fourth drive unit 254, the fifth drive unit 255, and the sixth drive unit 256 so that the arms 221 to 226 turn into a target position.

The robot 2 has an encoder 24 provided at a rotary shaft of the motor or the speed reducer of each drive unit and detecting an angle of rotation of the rotary shaft. Thus, the encoder 24 acquires position information of the robot arm 22. The position information refers to information representing the angle of rotation of each rotary shaft. The encoder 24 also has the function of transmitting the acquired position information to the control device 5 with respect to each rotary shaft.

Specifically, the encoder 24 includes a first encoder 241, a second encoder 242, a third encoder 243, a fourth encoder 244, a fifth encoder 245, and a sixth encoder 246.

The motor or the speed reducer of the first drive unit 251 is provided with the first encoder 241 detecting the angle of rotation of the rotary shaft thereof. The motor or the speed reducer of the second drive unit 252 is provided with the second encoder 242 detecting the angle of rotation of the rotary shaft thereof. The motor or the speed reducer of the third drive unit 253 is provided with the third encoder 243 detecting the angle of rotation of the rotary shaft thereof. The motor or the speed reducer of the fourth drive unit 254 is provided with the fourth encoder 244 detecting the angle of rotation of the rotary shaft thereof. The motor or the speed reducer of the fifth drive unit 255 is provided with the fifth encoder 245 detecting the angle of rotation of the rotary shaft thereof. The motor or the speed reducer of the sixth drive unit 256 is provided with the sixth encoder 246 detecting the angle of rotation of the rotary shaft thereof. Each rotary shaft may be provided with a plurality of encoders.

Each motor may be, for example, an AC server motor, a DC servo motor or the like. Each speed reducer may be, for example, a planetary-gear speed reducer, a strain wave gear device or the like.

Each motor is electrically coupled to the control device 5 via a motor driver, not illustrated. The encoder 24, too, is electrically coupled to the control device 5.

The robot system 1 may have various sensors such as an image pickup sensor like a camera, a force sensor, a pressure sensor, and a proximity sensor, in addition to the above components.

### 1.2. Configuration of Control Device

The control device 5 is communicatively coupled to the robot 2. The control device 5 and the robot 2 may be wire-connected or wirelessly connected.

The control device 5 shown in FIG. 2 has a drive control unit 51 and a communication monitoring unit 52.

The drive control unit 51 is communicatively coupled to each of the first drive unit 251, the second drive unit 252, the third drive unit 253, the fourth drive unit 254, the fifth drive unit 255, and the sixth drive unit 256. The drive control unit 51 is also communicatively coupled to each of the first encoder 241, the second encoder 242, the third encoder 243, the fourth encoder 244, the fifth encoder 245, and the sixth encoder 246.

The communication between the drive control unit 51 and each of the drive units 251 to 256 and the communication between the drive control unit 51 and each encoder 24 are, for example, serial communication using a communication packet.

The drive control unit 51 has the function of controlling the operation of each of the drive units 251 to 256 and thus controlling the driving of the robot 2. The hardware configuration of the drive control unit 51 is not particularly limited. The drive control unit 51 has, for example, a configuration having a processor such as a CPU (central processing unit) or MPU (micro processing unit), various memories including a volatile memory such as a RAM (random-access memory) and a non-volatile memory such as a ROM (read-only memory), and an external interface or the like.

The processor reads out and executes various programs or the like stored in the memory. Thus, the drive control unit 51 can execute processing such as drive control, various computations, and various determinations about the robot 2. Specifically, the drive control unit 51 controls the operation of each drive unit and the end effector 26, based on position information acquired from the encoder 24. Thus, the drive control unit 51 can cause the robot 2 to execute target work. The drive control unit 51 limits the driving of the robot 2 when the communication monitoring unit 52, described later, has detected a communication abnormality. The communication monitoring unit 52 may have the function of directly limiting the driving of the robot 2. Alternatively, both the drive control unit 51 and the communication monitoring unit 52 may have this function.

The drive control unit 51 may also have another component in addition to these configurations. The program or the like stored in the memory may be provided from outside via a network.

Meanwhile, the communication monitoring unit 52 is coupled to a communication line branching out from between the drive control unit 51 and the encoder 24. Therefore, a communication packet transmitted and received between the drive control unit 51 and the encoder 24 is also distributed to the communication monitoring unit 52.

The communication monitoring unit 52 has the function of monitoring the communication between the drive control unit 51 and the encoder 24. The hardware configuration of the communication monitoring unit 52 is not particularly limited. The communication monitoring unit 52 has, for example, a configuration having a processor such as an FPGA (field-programmable gate array) or ASIC (application-specific integrated circuit), various memories including a volatile memory such as a RAM and a non-volatile memory such as a ROM, and an external interface or the like. Also, various memories can be built in the FPGA or the like.

The communication monitoring unit 52 shown in FIG. 2 has a first monitoring unit 521 and a second monitoring unit 522.

The first monitoring unit 521 has a communication packet storage unit 5212, a status determination unit 5213, a count value generation unit 5214, a count value computation unit 5216, and a count value determination unit 5218.

The communication packet storage unit 5212 stores a communication packet distributed thereto. The communication packet storage unit 5212 is, for example, a memory having the function of FIFO (first-in, first-out).

FIG. 3 is a table showing an example of data stored in the communication packet storage unit 5212 shown in FIG. 2.

The data stored in the communication packet storage unit 5212 is divided into addresses having a predetermined bit width, as shown in FIG. 3. For example, numbers 0 to n are allocated to the addresses. The data is stored in order from the data having the address of 0 and is read out in order from the data having the address of 0.

In the communication packet storage unit 5212, the entirety of one communication packet is stored. Therefore, address numbers are suitably set according to the packet length of the communication packet. At the address 0, for example, the first synchronous frame of the communication packet is stored. At the address 1, for example, a count value generated by the count value generation unit 5214, described later, is stored. At the address 2 onward, for example, a received data portion of the communication packet is stored.

The status determination unit 5213 reads a status signal of the communication packet stored in the communication packet storage unit 5212 and determines whether the status signal satisfies a predetermined condition or not.

The count value generation unit 5214 is a free-running counter formed of a counter circuit with a predetermined number of bits. The count value generation unit 5214 in this embodiment generates, for example, a 31-bit-wide count value that increases at a frequency of 96 MHz. When the count value increases and overflows, the count value generation unit 5214 is reset to zero and then restarts count-up. When the communication packet transmitted and received between the drive control unit 51 and the encoder 24 is distributed to and stored into the communication packet storage unit 5212, the communication packet storage unit 5212 stores a count value corresponding to this timing along with the communication packet. Therefore, the count value generation unit 5214 functions as a first timer unit having a count value that is a time making a cycle of a finite time period. The frequency of generation of the count value and the bit width thereof are not particularly limited. The count value generation unit 5214 may also generate a count value that decreases.

The count value computation unit 5216 calculates the difference between a count value corresponding to the communication packet stored in the communication packet storage unit 5212 and a count value corresponding to a communication packet stored immediately before that communication packet.

The count value determination unit 5218 compares the difference between the count values calculated by the count value computation unit 5216 with a preset expected value. The count value determination unit 5218 then determines whether the difference between the count values is equal to the expected value or not. The communication monitoring unit 52 outputs the result of the determination by the count value determination unit 5218 to the drive control unit 51.

The second monitoring unit 522 has a no-communication time measuring unit 5222 and a no-communication time determination unit 5224. The first monitoring unit 521 and the second monitoring unit 522 are communicatively coupled together.

The no-communication time measuring unit 5222 detects a distributed communication packet and measures an elapsed time from the detection timing. The no-communication time measuring unit 5222 functions as a second timer unit measuring an elapsed time from the detection of a communication packet. Thus, the no-communication time measuring unit 5222 can measure a no-communication time between communication packets or a no-communication time after the last communication packet is detected.

The elapsed time may be a time period measured after a communication packet is detected, or a time period corresponding to that time period, for example, a computed value resulting from performing a predetermined computation on the measured time period. Also, the start point of measuring a time period may be the timing when a communication packet is detected, the timing when a communication packet is stored, or any other timing.

The no-communication time determination unit 5224 compares the no-communication time measured by the no-communication time measuring unit 5222 with a predetermined value. The no-communication time determination unit 5224 then determines whether the no-communication time is equal to or less than the predetermined value, or not. When the no-communication time exceeds the predetermined value, the no-communication time determination unit 5224 outputs information to that effect to the drive control unit 51.

### 2. Operations of Control Device

The operations of the control device 5 will now be described.

The communication monitoring unit 52 of the control device 5 is required to detect that a communication packet is normally transmitted and received, under various circumstances. Thus, the reliability of position information from the encoder 24 is secured and a reduction in the operation accuracy of the robot arm 22 can be restrained. That is, an inability to detect that the robot arm 22 is in an abnormal position, due to a drop in the reliability of position information caused by a communication disconnection, can be prevented. Thus, the robot system 1 with excellent safety can be achieved.

Operation examples of the control device 5 under various circumstances will now be described.

### 2.1. First Operation Example

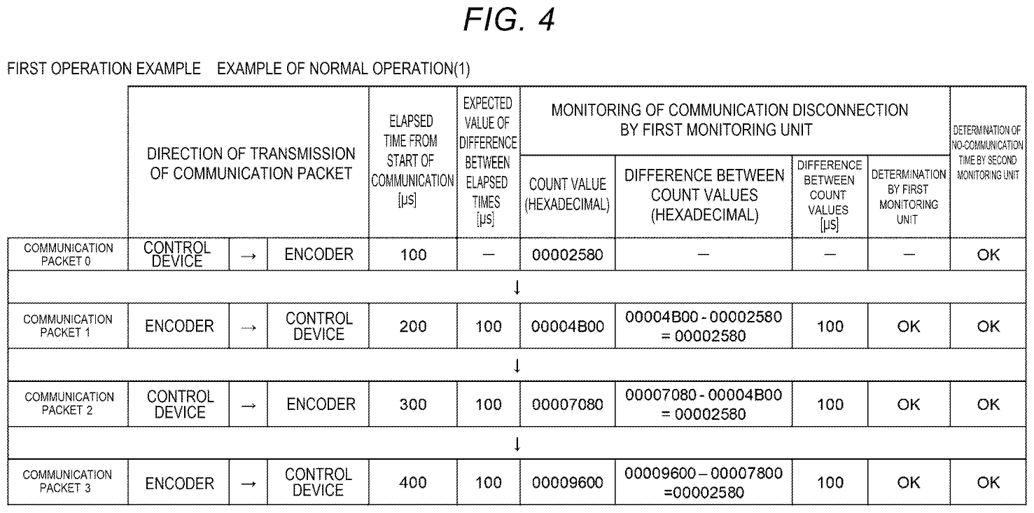

FIG. 4 is a table showing a first operation example of the control device 5. The first operation example is an example of normal operation where no communication abnormality has occurred. The table shown in FIG. 4 summarizes matters relating to each of a communication packet 0, a communication packet 1, a communication packet 2, and a communication packet 3 when these communication packets are distributed in this order to the communication monitoring unit 52.

The communication packet 0 is a communication packet transmitted from the control device 5 to the encoder 24. The communication packet 0 is transmitted at a timing when 100 ps have passed since the start of communication. The “elapsed time” in the table is described for the sake of convenience and is not the time measured in the control device 5.

As the communication packet 0 is distributed to the communication monitoring unit 52, the communication packet 0 is stored into the communication packet storage unit 5212. Also, a count value generated by the count value generation unit 5214 and coinciding with the timing when the communication packet 0 is stored is stored into the communication packet storage unit 5212 along with the communication packet 0. Here, for example, a hexadecimal count value “00002580” is stored into the communication packet storage unit 5212.

The communication packet 1 (first communication packet) is a communication packet transmitted from the encoder 24 to the control device 5. The communication packet 1 is transmitted at a timing when 200 μs have passed since the start of communication.

As the communication packet 1 is distributed to the communication monitoring unit 52, the communication packet 1 is stored into the communication packet storage unit 5212. Also, a count value generated by the count value generation unit 5214 and coinciding with the timing when the communication packet 1 is stored is stored into the communication packet storage unit 5212 along with the communication packet 1. Here, for example, a hexadecimal count value “00004B00” is stored into the communication packet storage unit 5212.

The communication packet 2 (second communication packet) is a communication packet transmitted from the control device 5 to the encoder 24. The communication packet 2 is transmitted at a timing when 300 μs has have passed since the start of communication.

As the communication packet 2 is distributed to the communication monitoring unit 52, the communication packet 2 is stored into the communication packet storage unit 5212. Also, a count value generated by the count value generation unit 5214 and coinciding with the timing when the communication packet 2 is stored is stored into the communication packet storage unit 5212 along with the communication packet 2. Here, for example, a hexadecimal count value “00007080” is stored into the communication packet storage unit 5212.

The communication packet 3 is a communication packet transmitted from the encoder 24 to the control device 5. The communication packet 3 is transmitted at a timing when 400 μs have passed since the start of communication.

As the communication packet 3 is distributed to the communication monitoring unit 52, the communication packet 3 is stored into the communication packet storage unit 5212. Also, a count value generated by the count value generation unit 5214 and coinciding with the timing when the communication packet 3 is stored is stored into the communication packet storage unit 5212 along with the communication packet 3. Here, for example, a hexadecimal count value “00009600” is stored into the communication packet storage unit 5212.

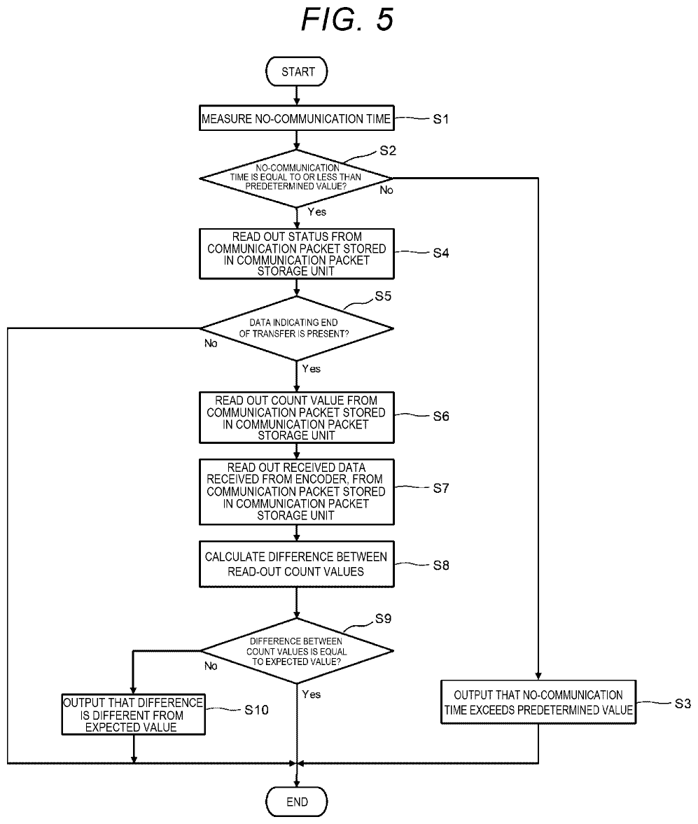

FIG. 5 is a flowchart for explaining a communication monitoring method by the communication monitoring unit 52. The communication monitoring method shown in FIG. 5 has steps S1 to S10. The communication monitoring unit 52 executes such steps at a slightly longer interval than the interval of transmitting and receiving a communication packet. For example, when the interval of transmitting and receiving a communication packet is 100 μs, the interval of executing communication monitoring may be set to approximately 500 μs. The interval of executing communication monitoring is not limited to this and can be changed according to need.

Here, for example, the case where the communication monitoring shown in FIG. 5 is executed at a timing after the communication packet 2 is transmitted is described.

In step S1 shown in FIG. 5, first, the no-communication time measuring unit 5222 measures a no-communication time with respect to the communication packet 2 distributed to the second monitoring unit 522. In this case, since it is after the communication packet 2 is detected, the no-communication time measured by the no-communication time measuring unit 5222 is less than 100 μs.

In step S2 shown in FIG. 5, whether the no-communication time is equal to or less than a predetermined value, or not, is determined. The predetermined value is suitably set, taking into account the effect of the no-communication time on the drive control of the robot 2, and the communication environment or the like. Here, for example, the predetermined value 10 ms. Thus, in step S2, whether the no-communication time is 10 ms or less, or not, is determined. When the no-communication time is less than 100 μs, as described above, it can be determined that the no-communication time is 10 ms or less. Therefore, the processing proceeds to step S4. In FIG. 4, the determination that the no-communication time is 10 ms or less is described as “OK”. Meanwhile, when the no-communication time exceeds 10 ms, the processing proceeds to step S3. In step S3, information that the no-communication time exceeds the predetermined value is outputted to the drive control unit 51. The drive control unit 51 can thus determine that an abnormality of some kind has occurred in the communication. Therefore, the drive control unit 51 can take measures such as limiting the driving of the robot 2. Thus, the safety of the robot system 1 can be increased.

In step S4 shown in FIG. 5, the status determination unit 5213 reads out a signal indicating a status from the communication packet storage unit 5212. The status signal may be, for example, a signal indicating whether data is stored at a predetermined address in the communication packet storage unit 5212 or not, a signal indicating whether the transfer of the communication packet has ended or not, or the like.

In step S5 shown in FIG. 5, the status determination unit 5213 determines whether data indicating the end of transfer is present in the status signal or not. VVhen data indicating the end of transfer is absent, the flow ends. Meanwhile, when data indicating the end of transfer is present, the processing proceeds to step S6.

In step S6 shown in FIG. 5, the count value computation unit 5216 reads out a count value corresponding to the communication packet 2 stored in the communication packet storage unit 5212.

In step S7 shown in FIG. 5, the count value computation unit 5216 reads out received data stored in the communication packet storage unit 5212.

In step S8 shown in FIG. 5, the count value computation unit 5216 calculates the difference between the count value corresponding to the communication packet 2 read out in step S6 and a count value corresponding to the communication packet 1 read out in advance. In FIG. 4, the formula for calculating the difference between the count values and the result of the calculation are expressed by hexadecimal numbers.

In step S9 shown in FIG. 5, the count value determination unit 5218 determines whether the calculated difference between the count values is equal to an expected value or not. When the difference is equal to the expected value, the flow ends. Meanwhile, when the difference is different from the expected value, the processing proceeds to step S10. In step S10, information that the difference between the count values is different from the expected value is outputted to the drive control unit 51. The drive control unit 51 can thus determine that an abnormality of some kind has occurred in the communication. Therefore, the drive control unit 51 can take measures such as limiting the driving of the robot 2. Thus, the safety of the robot system 1 can be increased.

In FIG. 4, an expected value of the difference between elapsed times is shown as an example. Also, a time calculated from the difference between count values is shown. When the calculated time coincides with the expected value, it can be determined that a communication disconnection has not occurred. Meanwhile, when the calculated time is different from the expected value, specifically when the calculated time has a greater value than the expected value, it can be determined that a communication disconnection has occurred. In FIG. 4, both the calculated time and the expected value are 100 μs and therefore the result of the determination is described as “OK”.

In this specification, the “expected value” is equivalent to the interval of transmitting a communication packet and is a prescribed value. However, the interval of transmission may change depending on the communication environment. Considering this, a small range of variance may be provided for the expected value.

### 2.2. Second Operation Example

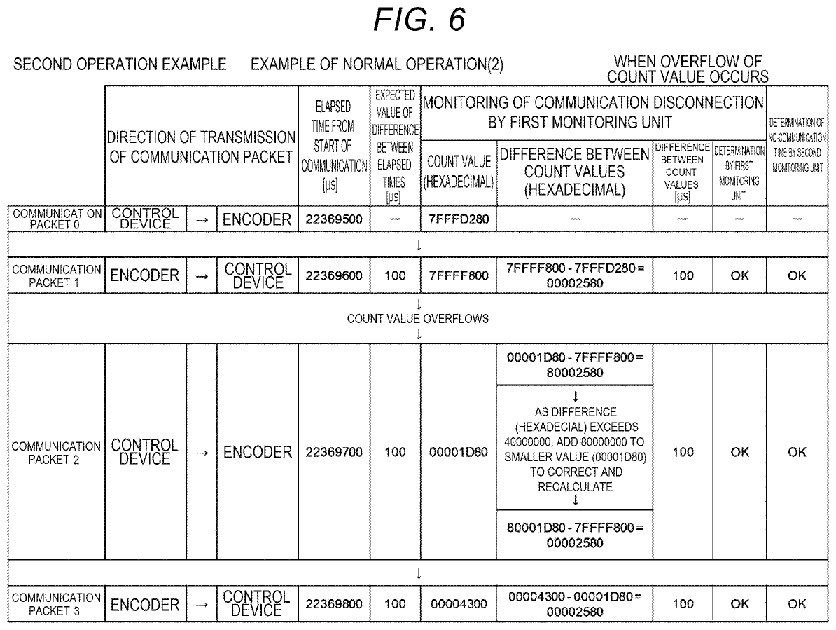

FIG. 6 is a table showing a second operation example of the control device 5. The second operation example, too, is an example of normal operation where no communication abnormality has occurred. However, in the control device 5, a free-running counter generating a count value making a cycle of a finite time period is used as the count value generation unit 5214. Therefore, when the count value overflows, the first monitoring unit 521 may make a determination error. In the second operation example, an operation to cope with such an overflow of the count value is described.

In the description of the second operation example, the difference from the first operation example is mainly described and the description of similar matters is omitted. The communication packet 0 and the communication packet 1 shown in FIG. 6 are similar to those in the first operation example shown in FIG. 4 except that the elapsed time from the start of communication is different. In the second operation example shown in FIG. 6, it is assumed that the count-up of the count value starts in line with the start point of the elapsed time and that the count value overflows after the communication packet 1 (first communication packet) is transmitted and distributed.

As the count value overflows, the hexadecimal count value is reset from 7FFFFFFF to 00000000. Therefore, calculating the difference between count values without considering the resetting of the count value in the foregoing step S8 results in an abnormal numerical value.

Thus, the count value computation unit 5216 in this embodiment has a correction function to avoid such a situation. Specifically, the count value stored in the communication packet storage unit 5212 corresponding to the communication packet 2 (second communication packet) is a value increased from the reset value of 00000000, as shown in FIG. 6. Therefore, calculating the difference without correcting the count value, 00001D80-7FFFF800=80002580, results in a very large value, that is, an abnormal value. Thus, the count value computation unit 5216 has the function of assuming that an overflow has occurred when the hexadecimal difference is a sufficiently large value, for example, more than 40000000. The count value computation unit 5216 then performs correction by adding 80000000 to the smaller value, that is, the reset count value of 00001D80. The count value computation unit 5216 then recalculates the difference, using the corrected count value. Thus, the correct difference is calculated.

As described above, the control device 5 in this embodiment has the count value generation unit 5214 generating a count value making a cycle of a finite time period. However, the control device 5 also has the correction function as described above and therefore can prevent the calculation of an abnormal value. Therefore, the occurrence of a problem due to using an abnormal value as it is, that is, the problem of erroneously recognizing that a communication disconnection has occurred even when no communication disconnection has occurred, can be prevented. Thus, unnecessary limitation on the driving of the robot 2 can be prevented.

### 2.3. Third Operation Example

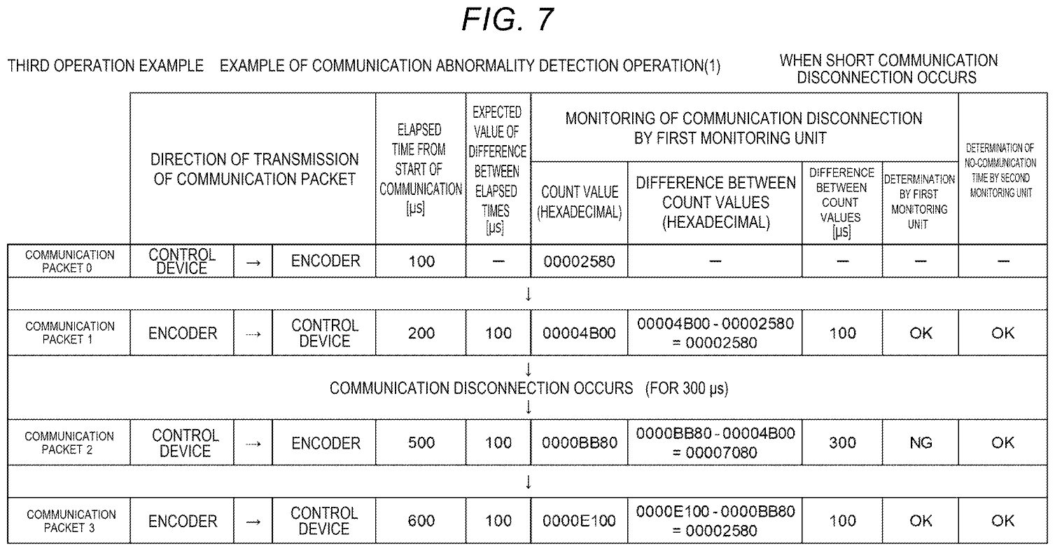

FIG. 7 is a table showing a third operation example of the control device 5. The third operation example is an operation example where a communication abnormality, specifically, a shorter communication disconnection than a predetermined value, described later, occurs.

In the description of the third operation example, the difference from the first operation example is mainly described and the description of similar matters is omitted. The communication packet 0 and the communication packet 1 shown in FIG. 7 are similar to those in the first operation example shown in FIG. 4.

In the third operation example, it is assumed that, after the communication packet 1 (first communication packet) is transmitted, a communication disconnection lasting 300 μs occurs in the communication line between the drive control unit 51 and the encoder 24 and the communication is subsequently restored.

First, in step S1, the no-communication time measuring unit 5222 measures a no-communication time. Then, in step S2, whether the measured no-communication time is equal to or less than a predetermined value, or not, is determined. The duration of the communication disconnection shown in FIG. 7 is 300 μs. Therefore, it can be determined that the no-communication time is equal to or less than the predetermined value. Since the duration of the communication disconnection in the third operation example is short, the second monitoring unit 522 cannot detect this communication disconnection.

In step S6, a count value corresponding to the communication packet 2 (second communication packet) is read out. Then, in step S8, the difference between the count value corresponding to the communication packet 2 and the count value corresponding to the communication packet 1 is calculated. The count value continues increasing even during the communication disconnection. Therefore, the time calculated from the count value corresponds to the actual elapsed time without being influenced by the duration of the communication disconnection. Thus, for the communication packet 2 shown in FIG. 7, the time calculated from the difference between the count values is 300 μs.

In step S9, whether the calculated difference between the count values is equal to the expected value or not is determined. Here, the time calculated from the difference between the count values and the time of the expected value are compared with each other to perform the determination. The communication packet 2 shown in FIG. 7 is transmitted when the elapsed time from the start of communication is 500 μs, due to the influence of the communication disconnection. However, since this communication disconnection is not intended, the expected value of the difference in the elapsed time for the communication packet 2 is 100 μs as expected. Therefore, the time calculated from the difference between the count values and the time of the expected value do not coincide with each other. Thus, in FIG. 7, the result of the determination by the first monitoring unit 521 with respect to the communication packet 2 is described as “NG”.

As described above, in the control device 5 in this embodiment, even when a short communication disconnection that cannot be detected by the second monitoring unit 522 occurs, the first monitoring unit 521 can detect this communication disconnection. Therefore, even when there is a time period during which the position information of the encoder 24 cannot be acquired due to a communication disconnection, this can be detected and the driving of the robot 2 can be limited. Thus, the safety of the robot system 1 can be increased.

### 2.4. Fourth Operation Example

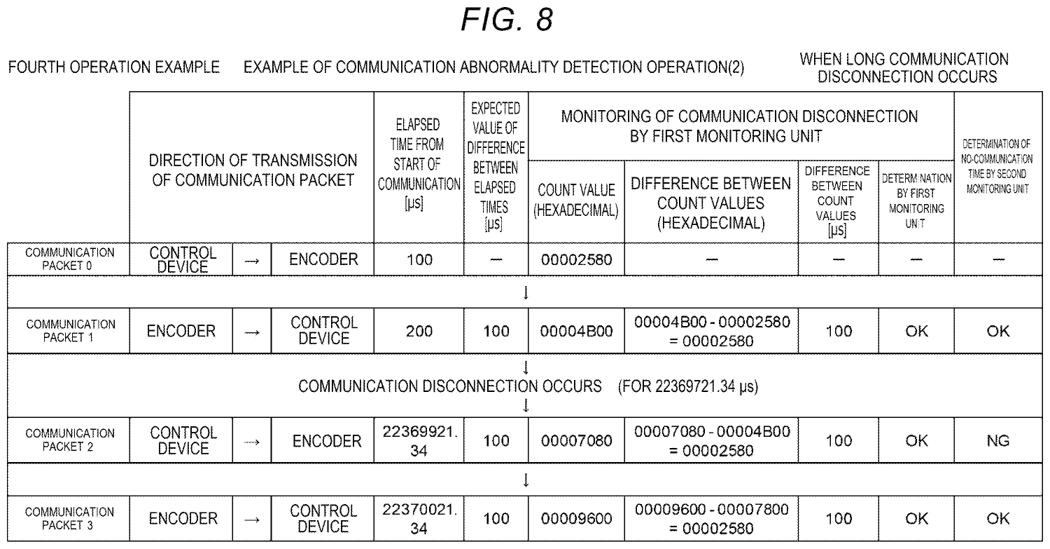

FIG. 8 is a table showing a fourth operation example of the control device 5. The fourth operation example is an operation example where a communication abnormality, specifically, a long communication disconnection exceeding a predetermined value, described later, occurs.

In the description of the fourth operation example, the difference from the first operation example is mainly described and the description of similar matters is omitted. The communication packet 0 and the communication packet 1 shown in FIG. 8 are similar to those in the first operation example shown in FIG. 4.

In the fourth operation example, it is assumed that, after the communication packet 1 (first communication packet) is transmitted, a communication disconnection lasting 22369721.34 μs occurs in the communication line between the drive control unit 51 and the encoder 24 and the communication is subsequently restored.

First, in step S1, the no-communication time measuring unit 5222 measures a no-communication time. Then, in step S2, whether the measured no-communication time is equal to or less than a predetermined value, or not, is determined. The duration of the communication disconnection shown in FIG. 8 is 22369721.34 μs. Therefore, it can be determined that the no-communication time exceeds the predetermined value. Then, in step S3, the second monitoring unit 522 outputs information that the no-communication time exceeds the predetermined value, to the drive control unit 51. Thus, even in the circumstance of the fourth operation example, the occurrence of a communication disconnection can be detected.

Meanwhile, the first monitoring unit 521 cannot detect this communication disconnection. The reason for this is described below.

In step S6, a count value corresponding to the communication packet 2 (second communication packet) is read out. Then, in step S8, the difference between the count value corresponding to the communication packet 2 and the count value corresponding to the communication packet 1 is calculated. The count value continues increasing even during the communication disconnection. Therefore, the time calculated from the count value corresponds to the actual elapsed time without being influenced by the duration of the communication disconnection. Thus, the duration of the communication disconnection can be calculated in the third operation example.

However, the count value corresponding to the communication packet 2 can make a round via an overflow and end up coinciding with the expected value, though with a very low probability. Specifically, when the count value has a 31-bit width and a communication disconnection lasting 22369721.34 μs occurs between the communication packet 1 and the communication packet 2, the count value corresponding to the communication packet 2 becomes 00007080. This value is the same as the count value corresponding to the communication packet 2 in the first operation example. In this case, when the difference is calculated using this count value and the time is calculated from this difference, no influence of the communication disconnection is included in the result of the calculation. That is, at the first monitoring unit 521, the time calculated from the difference between the count values is 100 μs, which is the same as in the first operation example. Therefore, the result of the determination is the same as when no communication disconnection has occurred. Thus, in FIG. 8, the result of the determination by the first monitoring unit 521 with respect to the communication packet 2 is “OK” even though the communication disconnection has occurred.

As described above, in the control device 5 in this embodiment, even when a relatively long communication disconnection with a predetermined length that cannot be detected by the first monitoring unit 521 occurs, the second monitoring unit 522 can detect this communication disconnection. That is, the monitoring function of the first monitoring unit 521 and the monitoring function of the second monitoring unit 522 are complementary with each other, as can be explained in the third operation example and the fourth operation example. Therefore, even when there is a time period during which the position information of the encoder 24 cannot be acquired due to a communication disconnection, this can be detected and the driving of the robot 2 can be limited. Thus, the safety of the robot system 1 can be increased.

### 2.5. Fifth Operation Example

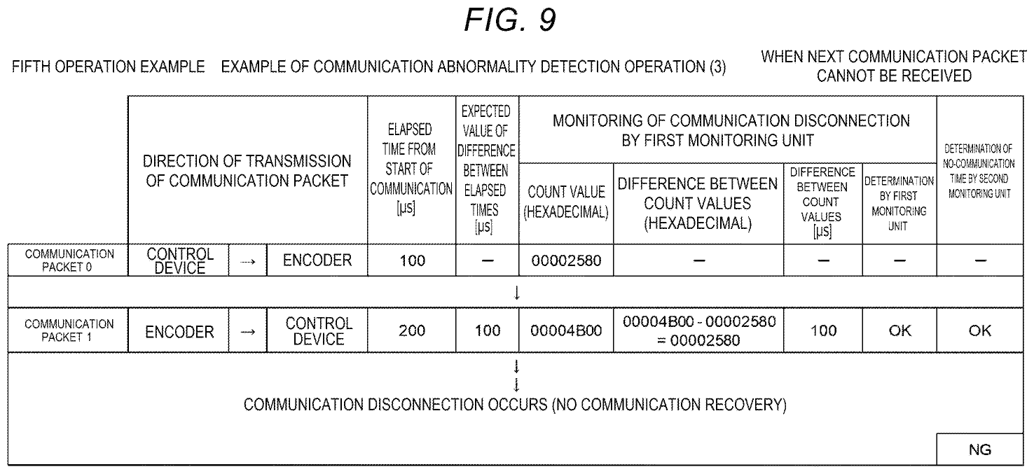

FIG. 9 is a table showing a fifth operation example of the control device 5. The fifth operation example is an operation example where a communicate abnormality occurs, specifically, a communication disconnection occurs and the communication is not subsequently restored.

In the description of the fifth operation example, the difference from the first operation example is mainly described and the description of similar matters is omitted. The communication packet 0 and the communication packet 1 shown in FIG. 9 are similar to those in the first operation example shown in FIG. 4.

In the fifth operation example, it is assumed that, after the communication packet 1 (first communication packet) is transmitted, a communication disconnection occurs in the communication line between the drive control unit 51 and the encoder 24 and the communication is not subsequently restored.

First, in step S1, the no-communication time measuring unit 5222 measures a no-communication time. Then, in step S2, whether the measured no-communication time is equal to or less than a predetermined value, or not, is determined. In the case of the communication disconnection shown in FIG. 9, the communication is not subsequently restored. Therefore, the no-communication time, which is initially equal to or less than the predetermined value, eventually exceeds the predetermined value over the course of repeated execution of the flow shown in FIG. 5. Therefore, the situation shown in FIG. 9 is basically the situation where the second monitoring unit 522 can detect the communication disconnection.

In step S3, the second monitoring unit 522 outputs information that the no-communication time exceeds the predetermined value, to the drive control unit 51.

Meanwhile, the first monitoring unit 521 cannot detect this communication disconnection. The reason for this is described below.

If the communication is not restored, there is no communication packet following the communication packet 1. In this case, the count value of the next communication packet cannot be acquired. Therefore, there is no count value that is necessary for the first monitoring unit 521 to determine the presence or absence of a communication abnormality, and the first monitoring unit 521 cannot perform determination. Thus, the drive control unit 51 cannot be notified of any abnormality, posing a problem in that the driving of the robot 2 cannot be limited.

In contrast, in the control device 5 in this embodiment, even when a communication disconnection occurs and the communication is not subsequently restored, the second monitoring unit 522 can detect this. Therefore, even in the circumstance where the communication is not restored, this can be detected and the driving of the robot 2 can be limited. Thus, the safety of the robot system 1 can be increased.

As described above, the robot system 1 according to this embodiment has the robot arm 22, the drive units 251 to 256, the encoder 24, the drive control unit 51, the communication packet storage unit 5212, the count value generation unit 5214 as the first timer unit, and the no-communication time measuring unit 5222 as the second timer unit. Of these, the drive units 251 to 256 drive the robot arm 22. The encoder 24 detects the position of the robot arm 22. The drive control unit 51 transmits and receives the communication packet 1 (first communication packet) and the communication packet 2 (second communication packet) in this order to and from the encoder 24 and controls the operation of the drive units 251 to 256, based on the contents of the communication packet 1 and the communication packet 2. The communication packet storage unit 5212 stores the communication packet 1 and the communication packet 2.

The count value generation unit 5214 has a count value that is a time making a cycle of a finite time period, and causes the communication packet storage unit 5212 to store the count value (first time) when the communication packet 1 is stored into the communication packet storage unit 5212 and the count value (second time) when the communication packet 2 is stored into the communication packet storage unit 5212.

The no-communication time measuring unit 5222 measures the elapsed time of the state of no communication after the communication packet 1 is detected.

In such a robot system 1, a communication disconnection can be detected, using the count value generated by the count value generation unit 5214 and the no-communication time measured by the no-communication time measuring unit 5222. Since the monitoring of communication based on the count value and the monitoring of communication based on the no-communication time are complementary with each other, a communication disconnection can be detected under various circumstances. Thus, the robot system 1 in which an abnormality occurring in the communication from the encoder 24 can be detected more securely using the results of such monitoring of communication, when the operation of the robot arm 22 is controlled based on the position information from the encoder 24, can be achieved.

The robot system 1 also has the communication monitoring unit 52 monitoring the state of communication between the encoder 24 and the drive control unit 51, based on the difference between the count value (first time) when the communication packet 1 is stored into the communication packet storage unit 5212 and the count value (second time) when the communication packet 2 is stored into the communication packet storage unit 5212, and based on the elapsed time of the state of no communication after the communication packet 1 is detected.

In such a configuration, the communication monitoring unit 52 can be easily made independent of the drive control unit 51 and therefore the independence and reliability of the operation of the communication monitoring unit 52 can be increased. Thus, the robot system 1 having an enhanced monitoring ability and higher functional safety can be achieved.

The communication monitoring unit 52 also has the function of reporting an abnormality in the state of communication when the elapsed time of the state of no communication after the communication packet 1 is detected exceeds a predetermined value. By outputting that the elapsed time exceeds the predetermined value, the communication monitoring unit 52 can detect a communication disconnection of such a degree as to influence the drive control of the robot 2 and can notify the drive control unit 51 of the communication disconnection. Thus, the robot system 1 having higher functional safety as the operation of the drive control unit 51 reflects the occurrence of the communication disconnection can be achieved.

The communication monitoring unit 52 also has the function of reporting an abnormality in the state of communication when the difference between the count value (first time) when the communication packet 1 is stored into the communication packet storage unit 5212 and the count value (second time) when the communication packet 2 is stored into the communication packet storage unit 5212 is deviated from the expected value. By outputting that the difference is different from the expected value, the communication monitoring unit 52 can detect a communication disconnection and notify the drive control unit 51 of the communication disconnection. Thus, the robot system 1 having higher functional safety as the operation of the drive control unit 51 reflects the occurrence of the communication disconnection can be achieved.

The drive control unit 51 also limits the driving of the robot arm 22, based on the result of monitoring by the communication monitoring unit 52. Thus, even when an abnormality occurs in the communication between the drive control unit 51 and the encoder 24 and the accurate position of the robot arm 22 cannot be detected, a collision between the robot arm 22 and a person or an object can be prevented. Thus, the robot system 1 having higher functional safety can be achieved.

The control device 5 for the robot 2 having the robot arm 22, the drive units 251 to 256, and the encoder 24 according to this embodiment has the drive control unit 51, the communication packet storage unit 5212, the count value generation unit 5214 as the first timer unit, and the no-communication time measuring unit 5222 as the second timer unit. Of these, the drive units 251 to 256 drive the robot arm 22. The encoder 24 detects the position of the robot arm 22. The drive control unit 51 transmits and receives the communication packet 1 (first communication packet) and the communication packet 2 (second communication packet) in this order to and from the encoder 24 and controls the operation of the drive units 251 to 256, based on the contents of the communication packet 1 and the communication packet 2. The communication packet storage unit 5212 stores the communication packet 1 and the communication packet 2.

The count value generation unit 5214 has a count value that is a time making a cycle of a finite time period, and causes the communication packet storage unit 5212 to store the count value (first time) when the communication packet 1 is stored into the communication packet storage unit 5212 and the count value (second time) when the communication packet 2 is stored into the communication packet storage unit 5212.

The no-communication time measuring unit 5222 measures the elapsed time of the state of no communication after the communication packet 1 is detected.

In such a control device 5, a communication disconnection can be detected, using the count value generated by the count value generation unit 5214 and the no-communication time measured by the no-communication time measuring unit 5222. Since the monitoring of communication based on the count value and the monitoring of communication based on the no-communication time are complementary with each other, a communication disconnection can be detected under various circumstances. Thus, the control device 5 that can more securely detect an abnormality occurring in the communication from the encoder 24, using the results of such monitoring of communication, when the operation of the robot arm 22 is controlled based on the position information from the encoder 24, can be achieved.

The robot system and the control device for the robot according to the present disclosure have been described, based on the illustrated embodiment. However, the present disclosure is not limited to this embodiment. The configuration of each part can be replaced by any configuration having a similar function. Also, any other component may be added to the embodiment.

What is claimed is:

1. A robot system comprising:
a robot arm;
a drive unit driving the robot arm;
an encoder detecting a position of the robot arm;
a drive control unit transmitting and receiving a first communication packet and a second communication packet in this order to and from the encoder and controlling an operation of the drive unit, based on a content of the first communication packet and the second communication packet;
a storage unit storing the first communication packet and the second communication packet;
a first timer unit having a time making a cycle of a finite time period, the first timer unit causing the storage unit to store a first time, which is the time when the first communication packet is stored into the storage unit, and a second time, which is the time when the second communication packet is stored into the storage unit; and
a second timer unit measuring an elapsed time of a state of no communication after the first communication packet is detected.

2. The robot system according to claim 1, further comprising
a communication monitoring unit monitoring a state of communication between the encoder and the drive control unit, based on a difference between the first time and the second time, and based on the elapsed time.

3. The robot system according to claim 2, wherein
the communication monitoring unit reports an abnormality in the state of communication when the elapsed time exceeds a predetermined value.

4. The robot system according to claim 2, wherein
the communication monitoring unit reports an abnormality in the state of communication when the difference between the first time and the second time is deviated from an expected value.

5. The robot system according to claim 2, wherein
the drive control unit limits driving of the robot arm, based on a result of monitoring by the communication monitoring unit.

6. A control device for a robot,
the robot comprising:
a robot arm;
a drive unit driving the robot arm; and
an encoder detecting a position of the robot arm,
the control device comprising:
a drive control unit transmitting and receiving a first communication packet and a second communication packet in this order to and from the encoder and controlling an operation of the drive unit, based on a content of the first communication packet and the second communication packet;
a storage unit storing the first communication packet and the second communication packet;
a first timer unit having a time making a cycle of a finite time period, the first timer unit causing the storage unit to store a first time, which is the time when the first communication packet is stored into the storage unit, and a second time, which is the time when the second communication packet is stored into the storage unit; and
a second timer unit measuring an elapsed time of a state of no communication after the first communication packet is detected.
